(19) United States
(12) Patent Application Publication
(10) Pub. No.: US 2018/0326477 A1
(43) Pub. Date: Nov. 15, 2018

(54) Cast Inflow And Outflow Openings For Cast-Steel And Cast Iron Pistons

(71) Applicant: KS Kolbenschmidt GmbH, Neckarsulm (DE)

(72) Inventor: Gregor Müller, Mannheim (DE)

(21) Appl. No.: 15/776,477

(22) PCT Filed: Nov. 17, 2016
(86) PCT No.: PCT/EP2016/077950

§ 371 Date: May 16, 2018

(30) Foreign Application Priority Data
Nov. 19, 2015 (DE) 10 2015 222 878.9

(51) Int. Cl. B22D 15/02; B22C 9/10; F02F 3/16

(52) U.S. Cl. CPC B22D 15/02; B22C 9/04; F02F 3/16; B22C 9/10

(57) ABSTRACT

Method for producing a piston having a cooling channel produced by a lost core casting process. A lost core extends into a casting mold which forms the inner region of the piston blank. The lost core is used to form at least one opening having a rounded profile in communication with the cooling channel. A jet splitter may be formed in the cooling duct to divert injected cooling oil into the cooling duct.

### TECHNICAL FIELD

The invention relates to a method for producing a piston which has a cooling duct that is generated by way of a lost core, wherein a piston blank is cast in a casting method using a casting melt and using a casting mold into which the core is inserted prior to casting, and the piston blank is removed from the casting mold after the solidification of the casting melt and the core subsequently is flushed out, and final processing of the piston blank is thereafter performed in order for the piston to be generated.

### BACKGROUND

Such a method for producing a piston, the latter also referred to as a cooling duct piston, is known from U.S. Pat. No. 4,559,685. A lost core, for example a sand core, at the ends thereof is provided with a metallic holding piece, wherein a permanent magnet onto which said metallic holding piece is placed and on account of which the latter is held is present in the casting mold. The lower side of the lost core that surrounds the metallic holding piece bears on the holding device in which the permanent magnet lies, such that a cylindrical end of the core is implemented on account thereof. Consequently, after flushing out the core from the finished cast piston blank, a transition having relatively sharp edges results in the material region of the piston blank that surrounds the cooling duct such that, as a result, stresses which can lead to the formation of fissures when the finished piston runs in the operation of the cylinder of the internal combustion engine are created in the structure of the material of the piston.

### SUMMARY

The invention is therefore based on the object of avoiding the disadvantages set forth at the outset.

It is provided according to the invention that the core extends into a region of the casting mold that configures an inner region of the piston blank, and at least one opening that has a rounded profile for the cooling duct is formed by way of the core after flushing. A seamless transition around the opening to the cooling duct can be implemented by means of extending the core into a region of the casting mold that configures an inner region of the piston blank. This opening in this instance does not only extend from the opening per se in the direction of the cooling duct but, proceeding from the opening, also extends in the opposite direction toward the inner region. Not only this extent of the profile of the opening but also the rounded profile of the opening for the cooling duct have the advantage that no transitions having sharp edges are created, such that the formation of fissures is effectively avoided on account thereof.

A further advantage can be seen in that arbitrary shapes of the opening can be implemented by means of a lost core, for example a salt or sand core. The cross section of the opening no longer has to be round but can also be oval, or have any other arbitrary shapes that have a cross-sectional profile of a rounded type. Moreover, it is a very substantial advantage that the lost core forms completely the opening region for access to the cooling duct, specifically also in a manner proceeding from the inner region of the piston such that the latter has to be flushed out only after the casting and the solidification of the casting melt. Chip-removing machining such as, for example, boring (in particular in order for the opening per se to be implemented), or post-processing by chip-removing methods, are completely dispensed with such that, according to the invention, there is no risk of comparatively small particles which are created in chip-removing machining being able to invade the cooling circuit of the internal combustion engine.

As an example of imparting arbitrary shapes it is provided in a refinement of the invention that at least one inflow opening having an encircling bead is formed as an opening by means of the core, optionally complemented by the formation of the opening by means of the lost core at least as an outflow opening, likewise having an encircling bead. As per the invention, an opening is thus not just simply incorporated from the direction of the inner region of the piston in the direction of the cooling duct, but said opening is also advantageously designed. By means of the encircling bead at least around the inflow opening, the latter region is not only reinforced but also imparted a shape by means of which fissures in the structure of the material around the opening are effectively avoided. Here too, the cross section of the opening does not have to be circular but, when viewed in the cross section, can also be oval or in terms of the circulation of said opening can be configured so as to have many variations of the profile of an arcuate shape.

In a refinement of the invention it is likewise provided that a jet splitter is formed by means of the core at least in the region of the inflow opening. This jet splitter lies in the apex of the cooling duct, for example, such that said jet splitter when viewed in the axis of the piston lift protrudes downward into the free region of the cooling duct. On account thereof, an oil jet that by way of the at least one inflow opening is injected in the direction of the cooling duct can be guided in a specific direction or else in two different directions.

### DETAILED DESCRIPTION

The invention will be described in more detail and be explained by means of the figures hereunder by means of a piston which is produced by the method according to the invention.

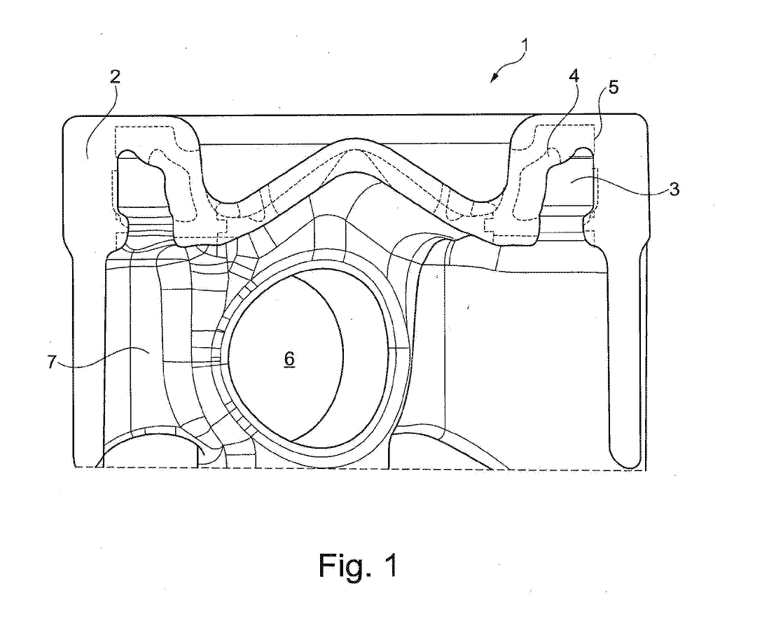

A piston blank 1 which after the production thereof has an external contour referred to by the reference sign 2 is illustrated in FIG. 1. The piston blank 1 is produced by means of a respective casting method using a casting mold, wherein the casting mold has the internal contour of the external contour 2 of the piston blank 1. The casting mold can be designed in one or a plurality of parts. A lost core 3 which in a suitable manner is disposed on the casting mold, for example on the inner insert of the casting mold, is provided as part of the casting mold. It is also conceivable for more than one lost core 3 to be provided. Once the at least one core 3 has been disposed on and fastened to the casting mold, the casting mold is filled with casting melt, time then being spent on waiting until said casting melt has solidified. The casting mold is subsequently removed, wherein the lost core 3 initially remains in the piston blank 1 produced. The latter is flushed out in the usual manner such that an inner region is created in the piston blank 1 on account thereof, said inner region corresponding to the external shape of the core 3 and forming a cooling duct 4. The contour illustrated in FIG. 1 or the profile of the cooling duct 4, respectively, is exemplary and not limited thereto.

A finished contour, once the piston blank 1 has been further processed, is designated by dashes and referred to by the reference sign 5. This final processing has been performed in particular by chip-removing machining of the external region of the piston blank 1. This final processing is performed either after or optionally prior to flushing out the core 3.

The completely processed piston finally has elements known per se, such as a ring zone, a bolt bore 6, a piston skirt 7, and further commonplace elements (such as, for example, optionally a combustion bowl).

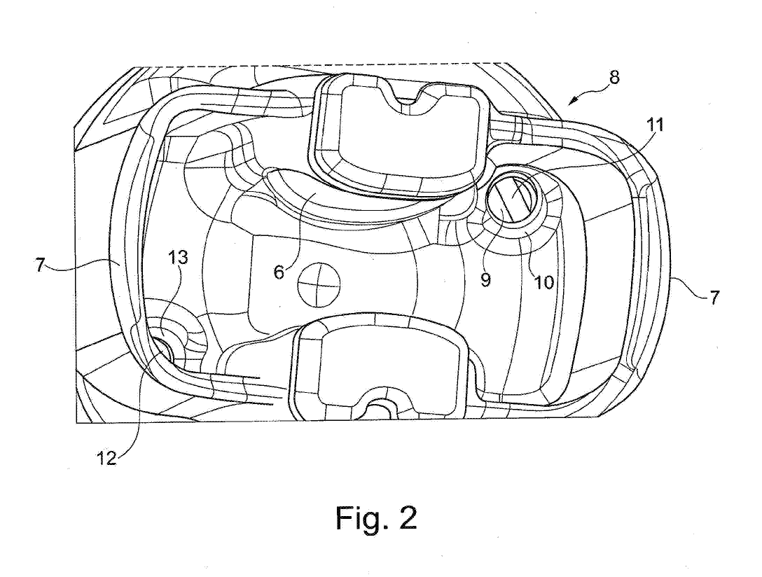

A view into an inner region of a finished piston 8 which is based on the piston blank 1 according to FIG. 1 is illustrated in FIG. 2. In the case of this exemplary design it can be seen that, proceeding from the bolt bores 6, connection walls extend in the direction of the load-bearing piston skirts 7. Said connection walls are disposed on the lower side of the upper part of the finished piston 8, wherein at least one inflow opening 9 is also located on said lower side. An encircling bead 10 is disposed around the inflow opening 9 in this exemplary embodiment. The cross section of the inflow opening 9 herein is circular but can deviate from this geometric shape. The same apples also to the encircling bead 10 in this instance.

When viewed through the inflow opening 9 in the direction of the lower side of the upper part of the piston 8, an optional jet splitter 11 in the cooling duct 4 is also illustrated (more specifically on the apex of the latter, so as to protrude downward in the direction of the inflow opening 9).

In the case of the piston 8 according to FIG. 2, the injection of cooling oil is performed by way of the (at least one) inflow opening 9 such that the cooling oil can circulate in the cooling duct 4. In order for said cooling oil to be able to exit the cooling duct 4 again, according to FIG. 2 at least one outflow opening 12 which can likewise be provided with an encircling bead 13 (this not being mandatory) is present. According to the invention, the openings 9, 12 (and optionally further openings) are produced by means of the lost core 3, wherein the rounded profile of the opening 9, 12, for example implemented having the encircling bead 10, 13 that serves for reinforcing the respective region, is also produced by means of the lost core which extends into a region of the casting mold that configures an inner region of the piston blank 1.

### A List of Drawing Reference Signs is Below.

1. Piston blank

2. External contour

3. Lost core

4. Cooling duct

5. Finished contour

6. Bolt bore

7. Piston skirt

8. Finished piston

9. Inflow opening

10. Encircling bead

11. Jet splitter

12. Outflow opening

13. Encircling bead

1. A method for producing a piston which has a cooling duct that is generated by way of a lost core, wherein a piston blank is cast in a casting method using a casting melt and using a casting mold into which the core is inserted prior to casting, and the piston blank is removed from the casting mold after the solidification of the casting melt and the core subsequently is flushed out, and final processing of the piston blank is thereafter performed in order for the piston to be generated, characterized in that the core extends into a region of the casting mold that configures an inner region of the piston blank, and at least one opening that has a rounded profile for the cooling duct is formed by way of the core after flushing.

2. The method of claim 1, further comprising forming at least one inflow opening having an encircling bead by means of the core, the at least one inflow opening in communication with the cooling duct.

3. The method of claim 1, further comprising forming at least one outflow opening having an encircling bead by means of the core, the at least one outflow opening in communication with the cooling duct.

4. The method of claim 2, further comprising forming a jet splitter by means of the core at least in the region of the inflow opening.

5. The method of claim 4 wherein the jet splitter is positioned in the cooling duct.

6. The method of claim 3 further comprising forming a jet splitter by means of the core at least in the region of the inflow opening.

7. A method for forming a piston blank comprising:
inserting a casting lost core into a casting mold having a cavity, the lost core defining an inner region of the piston blank;
extending a rounded portion of the lost core into the mold cavity defining a piston blank cooling duct and at least one cooling oil opening in communication with the cooling duct;
adding a casting melt into the casting mold cavity including the lost core forming the piston blank cooling duct and at least one cooling oil opening;
cooling the casting melt to solid form forming the piston blank;
removing the piston blank from the casting mold; and
flushing the lost core from the piston blank.

8. The method of claim 7 wherein the at least one cooling oil opening comprises an inflow opening.

9. The method of claim 8 wherein the at least one cooling oil opening further comprises an outflow opening.

10. The method of claim 8 further comprising forming by the lost core a jet splitter in the cooling duct axially adjacent the inflow opening, the jet splitter operable to engage and divert cooling oil injected through the at least one cooling oil opening into the cooling duct.
